(19) United States
(12) Patent Application Publication
(10) Pub. No.: US 2012/0038349 A1
(43) Pub. Date: Feb. 16, 2012

(54) Triple Hall Effect Sensor Absolute Angular Encoder

(76) Inventor: Norman Luwei Jin, Rochester Hills, MI (US)

(21) Appl. No.: 12/854,978

(22) Filed: Aug. 12, 2010

(51) Int. Cl. G01B 7/30

(52) U.S. Cl. 324/207.25

(57) ABSTRACT

The present invention is an array of three Hall Effect sensors placed at specific positions around a permanent magnet attached to a rotor or a magnetic rotor. The purpose of an absolute encoder is to provide the precise angular position of the rotor at any time. A magnetic absolute encoder uses sensors that read magnetic field values. The present invention is a novel design in the field of absolute encoders that increases encoder accuracy and resolution while avoiding the high cost that accompanies sophisticated sensors. This invention is a simple, effective and affordable solution to collect and process sensor information to determine rotor position. The position of the rotor can be determined to an accuracy of one degree.

### BACKGROUND ART

Magnetic Encoder U.S. Pat. No. 7,471,080. Sasaki, et al. Dec. 30, 2008

### BRIEF DESCRIPTION

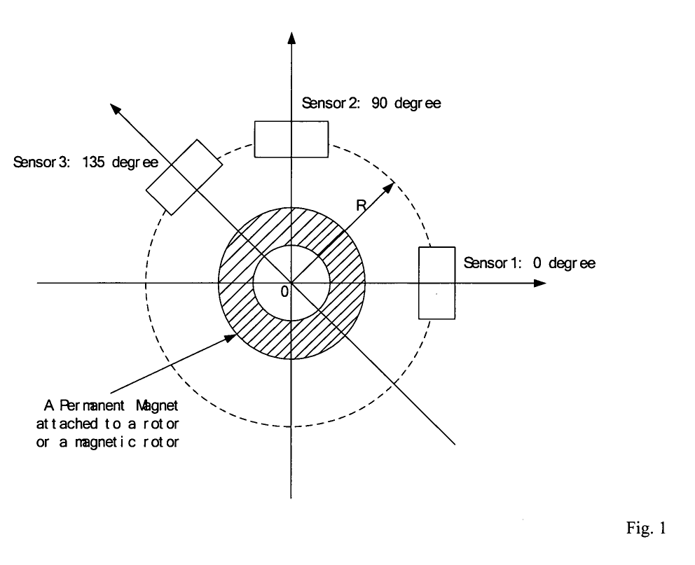

Magnetic absolute encoders of this design comprise a rotor with a permanent magnet or a magnetic rotor and a plurality of magnetic detection sensors. Two of the magnetic detection sensors are disposed in angular positions that are spatially separated by 90 degrees, and the third sensor is placed at a 45 degree angle from one of the two sensors and 135 degrees from the other (see FIG. 1).

The optimum output waveform from the sensors is a trapezoidal waveform with the vertices adjacent to the shorter base trisecting the period of the function. Thus, the position of the sensors shall be carefully mounted in their radial direction to optimize the quasi-linearity of the waveform, capitalizing on the saturation of the Hall Effect sensor when placed in a powerful magnetic field. The three sensors should be in the same plane and have the equal distance, R, to the center of the rotor shaft at the specified angles, as shown in FIG. 1. When the magnetic rotor rotates, the sensor output waveform shape varies with the distance R. The sensor output changes from a trapezoidal waveform (when R is small) to a sinusoidal waveform (when R is large). The trapezoidal shape of the sensor output produces a quasi-linear composite waveform, so that the rotor position can be more accurately determined through a software algorithm.

The present invention is an absolute rotational position encoder with the following features.

No tight tolerance parts required

Mechanically rugged and vibration resistant

Small size and low weight

Very low cost

### DISCLOSURE OF THE INVENTION

The present invention is an improvement on prior work in the field of magnetic encoders (See Background Art). Previously, sensors have been mounted solely at perpendiculars to give the greatest discrepancies in sensor values of different positions. However, there exists two points in the rotation of the magnetic rotor where the values of the sensory outputs are identical and thus the slope of each curve must be used to determine the rotor's position. As the sum of the outputs of the two sensors that are mounted orthogonally has minimal derivative at these two points, a third sensor is added at a specific mark (45 degrees from one sensor and 135 degrees from the other) to provide a maximum slope in the curve at these two particular points. The computer control algorithm that reads the sensor output from the encoder uses the sum of the two orthogonal sensor outputs as well as the value of the third sensor to make the most accurate position reading, although other methodologies of signal processing are possible. The linearization of the sensor outputs by the precise positioning of the sensors and the manipulation of sensor saturation yields a sum curve that maintains quasi-linearization over the vast majority of the curve. Because the curve is quasi-linear over such a large proportion of the curve, the areas where the encoder accuracy is compromised due to low slope are reduced.

### BEST MODE FOR CARRYING OUT THE INVENTION

The Hall Effect sensors must be installed equidistantly from the rotational axis of the rotor.

An algorithm must be developed to process the sensory output.

A suggested control scheme is as follows.

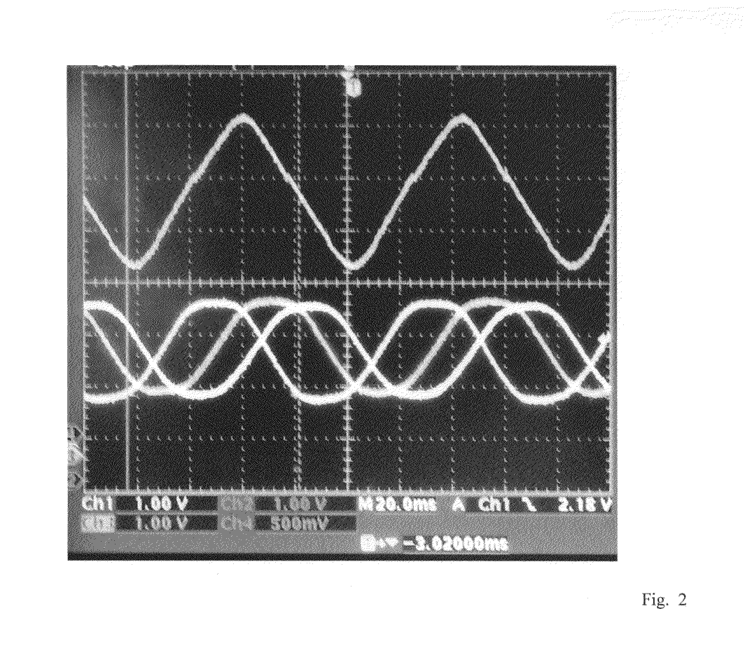

Let Sensor 1 be one of the sensors that are mounted orthogonally to another sensor. Let Sensor 2 be the other. Let Sensor 3 be the sensor that is mounted 135 and 45 degrees, respectively, from the other two sensors.
1. The controller stores sensor values at various rotor positions for the sum of the orthogonal sensors in a table. Sensor values for the third sensor are also stored in a table.
2. The value of the sum of the output from Sensor 1 and Sensor 2 (Green Curve, FIG. 2) is used to calculate the position of the rotor.
3. At the areas of minimum slope of the sum curve (near the critical points A′ and B′), the output from the third sensor has maximum slope and is used to increase encoder resolution and accuracy.

### Calibration

Before an absolute encoder of this design can be used, it must be calibrated to a magnetized rotor shaft. The calibration process is as follows.
1) The rotor is placed at an arbitrary but known position, and then driven by a stable rotational source 360 degrees with constant rotational speed. A recommended start position which to use as reference is the point of maximum of the sum of Sensors 1 and 2 (45 degree mark in FIG. 1).
2) During this rotation, magnetic sensor values for the sum of Sensor 1 and Sensor 2 versus the rotor positions are read and stored in a table A.
3) Simultaneously, magnetic sensor values for Sensor 3 versus the rotor positions are read and stored in a table B.
4) When this magnetic encoder is mounted in an application, axis rotational position can be calculated by the sum of the Sensor 1 and Sensor 2 outputs compared with the values stored in Table A (with interpolation if necessary). In the case where the axis position is close to 45 and 225 degrees in FIG. 1 (the positions of minimum resolution for Table A), Sensor 3's output compared with the values stored in Table B (with interpolation if necessary) should be used to determine the axis position.
   FIG. 1 is a diagram of one arrangement of the rotor detection sensors in this invention.

Note that the uniform distance between the sensors and the rotor axis. The optimum sensor placement will create the trapezoidal waveforms that aid in signal processing.

FIG. 2 depicts waveform traces of the output of the three sensors.

The red curve and the blue curve are outputs of the two sensors that are mounted orthogonally. The yellow curve is the output of the third sensor, which is placed to provide extra accuracy in determining rotor position. Because the derivatives of the red and blue curves are both low near their point of intersection, the third sensor is placed on a 45 degree and a 135 degree offset to maximize the derivative of the yellow curve at the points where the other two sensors provide minimum resolution. The green curve is the sum of the red and blue curves, used by the microcontroller to simplify the algorithm that determines rotor position from the sensor outputs.

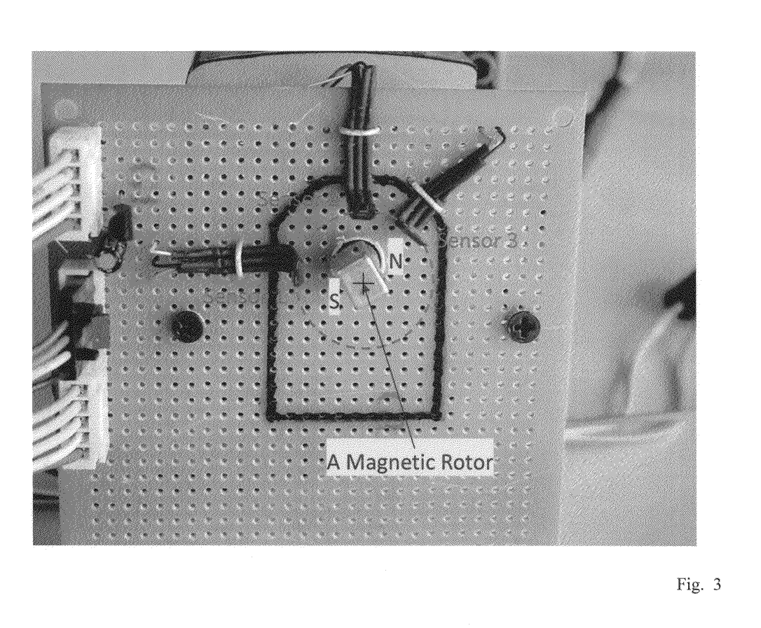

FIG. 3 shows a physical setup of the three sensors surrounding a magnetic rotor.

Note that the angles between the positioning of the sensors and the equidistance between each sensor and the axis of the magnetic rotor. This distance is optimized to control the saturation of the sensors as to create a trapezoidal waveform. The trapezoidal waveform is optimal for accurate computer analysis of the sensor outputs due to the linearity of a composite triangular waveform.

The invention claimed:

1. A magnetic absolute angular encoder comprising three magnetic sensors placed an equal distance from the center of a magnetic rotor and at 0, 90 and 135 degrees, respectively, either clockwise or counter clockwise from an arbitrary axis orthogonal to the axis of the rotor. The sensors are placed as to create a trapezoidal waveform; in addition, the sensors are placed at a precise distance as to have the sum of the two orthogonal sensors approximate a triangular waveform to ease signal processing and improve detection accuracy. The sensors are placed close enough to the magnetic rotor that the sensor is saturated during the closest approach of one of the poles of the rotor, creating the desired trapezoidal waveform.

2. The encoder described in claim 1 with additional sensors placed, including sensors placed to increase angular position detection accuracy.

3. The encoder described in claim 1 with sensors placed farther away from the rotor axis as to create a sinusoidal waveform.

4. The encoder described in claim 1 using the sum of two magnetic sensor outputs to yield a triangular or quasi-triangular waveform with linear response to the axis angular position to improve rotor position measurement.

5. The encoder described in claim 1 with the third sensor placed as to maximize output slope when the rotor axis is in the position where the sinusoidal or triangular or quasi-triangular composite waveform from the two orthogonal sensors reaches its two intersection values (see A′ and B′ in FIG. 2).

6. The encoder described in claim 1, achieving high rotor position accuracy by interpolating both the sum of the two magnetic sensor output readings and the third magnetic sensor output readings through calibrated look-up tables.

7. The encoder described in claim 1 using an alternative control algorithm to process sensor output from the sensor array described in claim 1.

8. A magnetic absolute encoder utilizing the method of saturating sensors to linearize sensor outputs, including absolute encoders that do not contain the exact sensor arrangement described in claim 1.
